(19) United States
(12) Patent Application Publication
(10) Pub. No.: US 2025/0038535 A1
(43) Pub. Date: Jan. 30, 2025

(54) POWER MANAGEMENT SYSTEM AND POWER MANAGEMENT METHOD

(71) Applicant: TOYOTA JIDOSHA KABUSHIKI KAISHA, Toyota-shi (JP)

(72) Inventors: Akinori MORISHIMA, Naka-gun (JP); Takafumi MATSUMURA, Ashiya-shi (JP)

(73) Assignee: TOYOTA JIDOSHA KABUSHIKI KAISHA, Toyota-shi (JP)

(21) Appl. No.: 18/737,394

(22) Filed: Jun. 7, 2024

(30) Foreign Application Priority Data
Jul. 24, 2023 (JP) 2023-119653

(51) Int. Cl. H02J 3/32; B60L 53/68; H02J 7/00

(52) U.S. Cl. CPC H02J 3/32; H02J 7/0071; H02J 7/00712; B60L 53/68

(57) ABSTRACT

In the plan control, the control right of HEMS is held by the energy management server 2, and HEMS is controlled based on a power supply and demand plan developed in advance. The edge-control is such that HEMS controllers has a control right of HEMS and control HEMS based on the actual status of HEMS surplus power and power demand. HEMS includes an electrified vehicle (storage battery). The energy management server 2 switches the power management control from the edge control to the planning control when it is predicted that the actual SOC of electrified vehicle 12 is insufficient for the target SOC at the scheduled departure time of electrified vehicle during the execution of the edge control.

### CROSS-REFERENCE TO RELATED APPLICATION

This application claims priority to Japanese Patent Application No. 2023-119653 filed on Jul. 24, 2023, incorporated herein by reference in its entirety.

### BACKGROUND

### 1. Technical Field

The present disclosure relates to power management systems and power management methods, and more particularly, to a system and method for managing power supply and demand in a power grid including a plurality of power balancing resources.

### 2. Description of Related Art

Japanese Unexamined Patent Application Publication No. 2016-187254 (JP 2016-187254 A) discloses a method for controlling a storage battery so as to reduce loss of power generated using renewable energy, and a method for controlling a water heater that can be controlled so that power supply does not fall below a minimum required power value. JP 2016-187254 A also describes calculating a prediction error of prediction data using an operation plan data for the storage battery and an actual operation performance data.

### SUMMARY

In a power grid including a plurality of power balancing resources, there are not only cases where the actual power supply and demand of some power balancing resources (e.g., a home energy management system that will be described later) changes according to a power supply and demand plan, but also cases where the actual power supply and demand deviate from the power supply and demand plan.

In the case where a storage battery (e.g., an electrified vehicle that is chargeable with power supplied from charging equipment outside the vehicle) is included as a power balancing resource, the storage battery may not be able to be sufficiently charged when, for example, the power generation amount of a photovoltaic power generation facility falls below a predicted power generation amount. It is desirable that user convenience is not impaired even if such a situation occurs.

The present disclosure was made to solve the above issue, and it is one object of the present disclosure to ensure user convenience when a storage battery is included as a power balancing resource.

A power management system according to an aspect of the present disclosure manages power supply and demand in a power grid including a plurality of power balancing resources. The power management system includes:
a controller configured to charge or discharge a corresponding resource that is a corresponding one of the power balancing resources; and
a server configured to set power management control to be performed on the corresponding resource by the controller.

The power management control includes first control and second control.

In the first control, the server has a control right of the corresponding resource and controls the corresponding resource based on a power supply and demand plan developed in advance. In the second control, the controller has the control right and controls the corresponding resource based on an actual situation of surplus power and power demand of the corresponding resource.

The corresponding resource includes a storage battery that is chargeable with power supplied from external charging equipment.

When a prediction is made during the second control that an actual state of charge (SOC) of the storage battery is going to be lower than a target SOC at a scheduled time to use the storage battery, the server switches the power management control from the second control to the first control.

A power management method according to another aspect of the present disclosure manages power supply and demand in a power grid including a plurality of power balancing resources.

The power management method includes a setting step of setting, by a server, power management control to be performed on a corresponding resource by a controller, the corresponding resource being a corresponding one of the power balancing resources.

The power management control includes first control and second control.

In the first control, the server has a control right of the corresponding resource and controls the corresponding resource based on a power supply and demand plan developed in advance. In the second control, the controller has the control right and controls the corresponding resource based on an actual situation of surplus power and power demand of the corresponding resource.

The corresponding resource includes a storage battery that is chargeable with power supplied from external charging equipment.

The setting step includes a step of switching the power management control from the second control to the first control when a prediction is made during the second control that an actual SOC of the storage battery is going to be lower than a target SOC at a scheduled time to use the storage battery.

According to the present disclosure, it is possible to ensure user convenience when a storage battery is included as a power balancing resource.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of an overall configuration of a power management system according to an embodiment of the present disclosure;

FIG. 2 is a time chart for explaining an outline of power management control according to the present embodiment;

FIG. 3 is a diagram for describing switching from edge-control to planning control; and

FIG. 4 is a flowchart illustrating an example of a processing procedure of power management control according to the present embodiment.

### DETAILED DESCRIPTION OF EMBODIMENTS

Hereinafter, embodiments of the present disclosure will be described in detail with reference to the drawings. In the drawings, the same or corresponding portions are denoted by the same reference signs and the description thereof will not be repeated.

### EMBODIMENT

### System Configuration

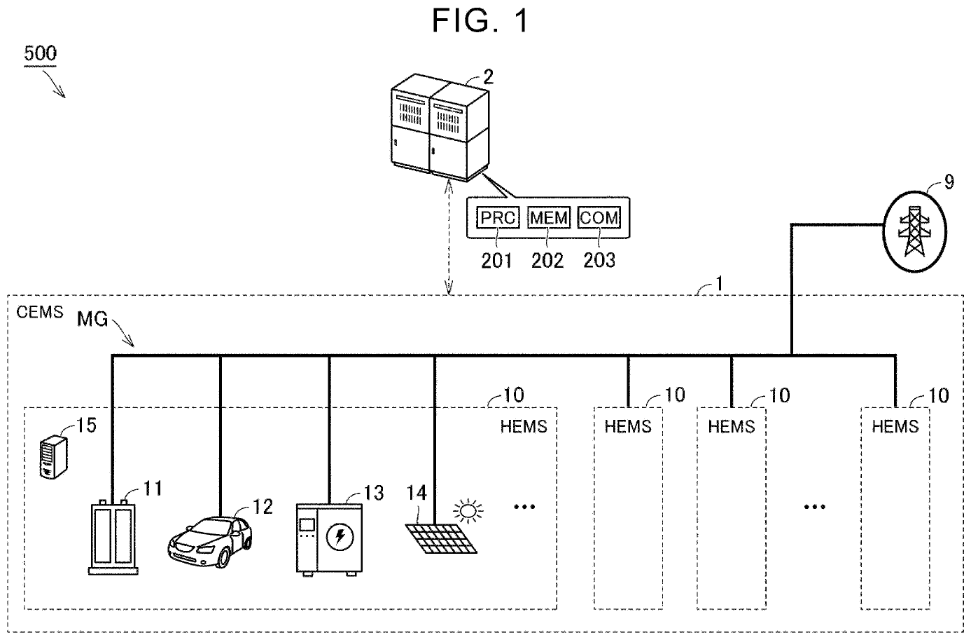

FIG. 1 is a diagram illustrating an overall configuration of a power management system according to an embodiment of the present disclosure. The power management system 500 includes a CEMS 1 and an energy management server 2.

CEMS 1 means Community Energy Management System or City Energy Management System. CEMS 1 includes, for example, a Home Energy Management System (HEMS) 10. In CEMS 1, a microgrid MG is constructed by a plurality of HEMS 10. The microgrid MG is connected to the power system 9 so as to be capable of transmitting and receiving power to and from the power system 9. The power system 9 is an electric power grid constructed by a power plant and a transmission and distribution facility.

Note that the micro-grid MG is an exemplary “power grid” according to the present disclosure. CEMS 1 may comprise Factory Energy Management System (FEMS) instead of or in addition to HEMS 10, or may comprise Building Energy Management System (BEMS). CEMS 1 may include only one of the energy management systems.

Each of the plurality of HEMS 10 manages power used in the home (power consumed, demand, and supplied). HEMS 10 include, for example, a water heater 11, an electrified vehicle 12, a storage battery 13, a photo voltaic (PV) power generation facility 14, and HEMS controllers 15.

The water heater 11 is, for example, a water heater of a cogeneration system (which may be a water heater utilizing heat generated at the time of private power generation or a heat pump water heater). The water heater 11 boils the optimum amount of hot water corresponding to the usage amount of hot water for each household at night using inexpensive midnight power, and stores the boiled water in a hot water storage tank in preparation for use on the next day (so-called boiling).

Electrified vehicle 12 is vehicles including a storage battery (not shown), and specifically, plug-in hybrid electric vehicle (PHEV), battery electric vehicle (BEV), and the like. Electrified vehicle 12 is configured to receive power from the microgrid MG by connecting a charging cable extending from charging equipment (not shown) to an inlet (not shown) of electrified vehicle 12 (external charging). Electrified vehicle 12 may be configured to be dischargeable to the microgrid MG by connecting a charge cable to an outlet (not shown) of electrified vehicle 12 (external discharge). In this way, electrified vehicle 12 also functions as a movable storage battery. However, the “storage battery” according to the present disclosure is not limited to an in-vehicle storage battery, and may be a stationary storage battery.

The storage battery 13 is a stationary power storage device that stores electric power generated during daytime by PV power generation facility 14. The storage battery 13 may be a secondary battery such as a lithium-ion battery or a nickel-metal hydride battery, and may be manufactured using, for example, a traveling storage battery mounted 10 on a vehicle in the past.

PV power generation facility 14 receives sunlight in the daytime to generate electric power, and charges the storage battery 13 with the generated electric power and outputs the electric power to the microgrid MG. HEMS 10 may instead of or in addition to PV power generation facility 14 include other naturally varying power sources, such as wind 15 power generation facilities (power generation facilities where power generation power varies depending on weather conditions).

The above-described device is merely an example, and HEMS 10 may further include other devices (electric devices or V2H devices such as an air conditioner, a fuel cell, a lighting device, a generator, a heat storage tank, and the like) other than the above-described devices (not shown). Each device in HEMS 10 corresponds to a “power balancing resource” according to the present disclosure.

HEMS controllers 15 are configured to be able to communicate with the respective devices in HEMS 10. HEMS controllers 15 acquire the information of the respective devices and control the operation of the respective devices.

HEMS controllers 15 are also configured to communicate bi-directionally with the energy management servers 2. HEMS controller 15 transmits, to the energy management server 2, a value (power value, status value, and the like) indicating the operation status of the device acquired from the respective devices. In addition, HEMS controllers 15 control the respective devices in accordance with control commands from the energy management servers 2.

The energy management server 2 is a host computer (cloud server) that integrally manages a plurality of HEMS controllers 15. The energy management server 2 includes a processor 201, a memory 202, and a communication interface 203. The processor 201 executes various processes by reading out programs and various kinds of data (maps, relational expressions, parameters, and the like) stored in the memory 202 and expanding the programs and the various kinds of data in the memory 202. The communication interface 203 is configured to communicate with each of the plurality of HEMS controllers 15. The energy management server 2 performs “power management control” for each of the plurality of HEMS 10 to manage charge, power dissipation, and/or discharge in HEMS 10. This control will be described later.

Each of the plurality of HEMS controllers 15 corresponds to a “controller” according to the present disclosure. The energy management server 2 corresponds to a “server” according to the present disclosure.

### Power Management Control

The energy management server 2 develops a power supply and demand plan for each HEMS 10 that is a customer in CEMS 1, based on the electricity rate unit price of HEMS 10 and the power-receiving-end power prediction, so that the electricity rate of HEMS 10 is minimized. Then, the energy management server 2 executes “plan control” in accordance with the power supply and demand plan for each HEMS 10. In the planning control, the control right of each device in HEMS 10 is held in the energy management server 2, and the energy management server 2 cooperatively controls each device in HEMS 10. As a result, it is possible to maximize the self-consumption in HEMS 10 and suppress the electricity rate.

However, the actual supply and demand of electric power HEMS 10 does not necessarily change in accordance with the power supply and demand plan of electric power. The behavior of a consumer on one day may differ from that of a consumer on another day (normal behavior pattern). Alternatively, the weather may change from moment to moment, or the weather may change differently than expected based on historical data. As a consequence, there is a possibility that the power generation amounts of the natural variable power sources, such as PV power generation facility 14, may change differently than predicted. In addition, it is difficult to develop precise power supply and demand plans with short time granularity (e.g., in units of a minute). Therefore, there are cases where the power forecast is deviated, and thereby the actual power supply and demand of HEMS 10 is deviated from the power supply and demand planning. If the actual power supply and demand deviates from the power supply and demand plan, there is a possibility that private consumption cannot be maximized by the plan control alone. In other words, there is a possibility that the amount of electric power trading (the amount of electric power purchased and/or the amount of electric power sold) increases as compared with a case where the actual electric power supply and demand is in accordance with the electric power supply and demand plan, and the electric charge increases accordingly.

In the present embodiment, during a period in which it is predicted that the actual power supply and demand is out of the power supply and demand plan during the execution of the plan control, in this example, during a period in which it is predicted that the excess power is sold by PV power generation facility 14 or that the power purchase accompanying the increase in the power demand of the equipment (air conditioner, illumination device) in HEMS 10 occurs, the energy management server 2 switches the power management control from the “plan control” to the “edge control”.

In the edge-control, the control rights of the respective devices in HEMS 10 are transferred from the energy management server 2 to HEMS controllers 15. HEMS controllers 15 monitor the power at the receiving end in HEMS 10. Then, HEMS controllers 15 closely control the charging and discharging of the respective devices (the water heater 11, electrified vehicle 12, and the storage battery 13 in this embodiment) in HEMS 10 in accordance with the change in the amount of electric power buying and selling at the power receiving end of HEMS 10. As a result, the amount of electric power to be sold at the power receiving end of HEMS 10 can be reduced, and the self-consumption can be maximized. Consequently, the electricity rate in HEMS 10 can be reduced. Note that the plan control corresponds to “first control” according to the present disclosure, and the edge control corresponds to “second control” according to the present disclosure.

Switching between Plan Control and Edge Control

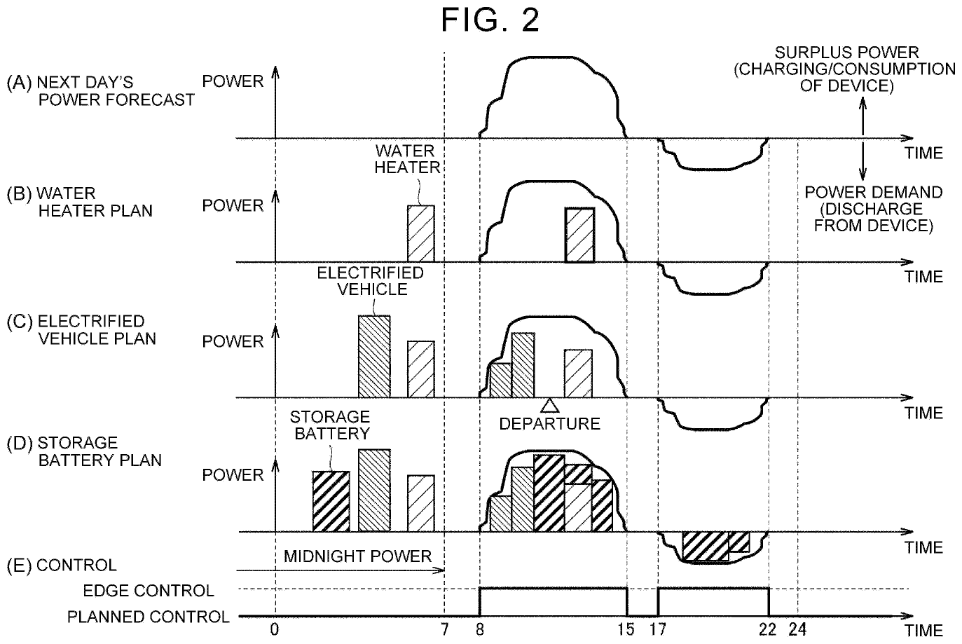

FIG. 2 is a time chart for explaining an outline of the power management control according to the present embodiment. The horizontal axis represents elapsed time. More specifically, the horizontal axis represents the elapsed time in a certain target period (in this example, a period from 0:00 to 24:00 on the next day). The vertical axis represents power (generated power or power demand). In FIG. 2, from the top, the following types of HEMS 10 are shown: the next-day power forecast in HEMS 10, the operation plan of the water heater 11, the operation plan of electrified vehicle 12, the operation plan and power management control of the storage battery 13.

For the target HEMS 10, the energy management server 2 predicts the power-receiving-end power in the target period at a predetermined timing. In this example, it is assumed that prediction is performed at a timing of 0 o'clock, and as a result, surplus power is generated in a period from 8 o'clock to 15 o'clock, and power demand (that is, power shortage) is predicted to occur in a period from 17 o'clock to 22 o'clock. In addition, it is assumed that inexpensive midnight power can be used in a period from night to 7 o'clock.

It is predicted that neither surplus power nor power demand will be generated in the period from 0:00 to 8:00. Therefore, the energy management server 2 executes the plan control. Therefore, the control rights of the devices in HEMS 10 are maintained by the energy management server 2.

During the period up to 7:00 of the period, the energy management server 2 performs the following control using inexpensive midnight power. First, the energy management server 2 determines the boiling-up time of the water heater 11. In this example, the energy management server 2 controls the water heater 11 so as to boil at least a part of the optimum amount of water by using the midnight power in order to boil up the optimum amount of water by 17:00, when the generation of power demand is predicted. Second, the energy management server 2 charges electrified vehicle 12 so that SOC of electrified vehicle 12 reaches the target at the scheduled departure time of electrified vehicle 12. In this case, the energy management server 2 charges SOC (e.g., SOC=80%) to at least an intermediate SOC (e.g., SOC=60%) using midnight power so that electrified vehicle 12 reaches the target SOC at 12:00, which is the scheduled departure time. Third, the energy management server 2 charges the storage battery 13 using midnight power. Note that the scheduled departure time of electrified vehicle 12 is an exemplary “scheduled use time of the storage battery” according to the present disclosure.

It is predicted that surplus power will be generated in the period from 8:00 to 15:00. Accordingly, there is a high possibility that electric power is sold at the power receiving end of HEMS 10. Therefore, the energy management server 2 switches the power management control from the plan control to the edge control. Therefore, the control rights of the devices in HEMS 10 are delegated from the energy management server 2 to HEMS controllers 15.

HEMS controllers 15 control the actual power consumption (the sum of the charged power or the power consumption of each device) of HEMS 10 so as to be within the surplus power and to be as close to the surplus power as possible in order to reduce the amount of electric power sold at the power receiving end of HEMS 10. In this case, first, HEMS controllers 15 charge electrified vehicle 12 with electric power corresponding to the remaining SOC (for example, the remaining 20% from 60% to 80%) from SOC where the charging is stopped halfway to the final SOC so that SOC of electrified vehicle 12 reaches the target SOC by the scheduled departure time of electrified vehicle 12. Further, HEMS controllers 15 control the water heater 11 so as to boil the remaining hot water (the difference between the optimum amount of hot water and a part of the hot water boiled by using the surplus electric power) using the midnight power so as to boil up the optimum amount of hot water by 17:00 when power demand is generated. Further, HEMS controllers 15 charge the storage battery 13 with electric power that is not charged or consumed by the water heater 11 and electrified vehicle 12 among the surplus electric power (electric power obtained by subtracting the electric power consumed by the water heater 11 and the electric power charged by electrified vehicle 12 from the surplus electric power).

During the period from 15:00 to 17:00, neither surplus power nor power demand is expected to be generated. Therefore, the energy management server 2 returns the power management control from the edge control to the plan control. Accordingly, the energy management server 2 recovers the control rights of the respective devices in HEMS 10 from HEMS controllers 15.

During the period from 17:00 to 22:00, power demand is expected to be generated. Accordingly, there is a high possibility that power is purchased at the receiving end of HEMS 10. Therefore, the energy management server 2 switches the power management control from the plan control to the edge control again. Therefore, the control rights of the devices in HEMS 10 are delegated from the energy management server 2 to HEMS controllers 15.

HEMS controllers 15 control the actual supplied power (the sum of the discharged power from the respective devices) of HEMS 10 so as to be within the range of the power demand and to be as close to the power demand as possible in order to reduce the amount of power purchased at the power receiving end of HEMS 10. In this embodiment, HEMS controllers 15 discharge the storage batteries 13. Although not shown, if electrified vehicle 12 is returning from the outing destination, HEMS controllers 15 may discharge electrified vehicle 12.

During the period from 22:00 to 24:00, neither surplus power nor power demand is expected to be generated. Therefore, the energy management server 2 returns the power management control from the edge control to the plan control. Accordingly, the energy management server 2 recovers the control rights of the respective devices in HEMS 10 from HEMS controllers 15.

As described above, in the present embodiment, the power management control for HEMS 10 is switched from the planning control to the edge-control during a period in which surplus power or power demand is predicted to be generated in HEMS 10. Then, the control rights of the respective devices in HEMS 10 are delegated to HEMS controllers 15. This allows HEMS controllers 15 to control the respective devices in HEMS 10 while monitoring the actual power receiving end power in HEMS 10 in real time. That is, in response to a change in the power receiving end power of HEMS 10, HEMS controllers 15 can control the power (the charge power, the power consumed, and/or the discharge power) of the devices in HEMS 10 in short-time units. Therefore, according to the present embodiment, it is possible to maximize the self-consumption of HEMS 10 and thereby reduce the amount of electric power buying and selling at the power receiving end of HEMS 10. Consequently, the electricity rate in HEMS 10 can be reduced.

Switching from Edge Control to Planning Control

HEMS 10 includes electrified vehicle 12 as a power balancing resource. When the power generation amount of PV power generation facility 14 (which may be another natural variation power source) is lower than the predicted amount or the power consumption amount of the device (the device other than electrified vehicle 12) in HEMS 10 is higher than the predicted amount during the edge-control, there is a possibility that adequate power cannot be supplied to electrified vehicle 12. It is desirable that user convenience is not impaired even if such a situation occurs. Therefore, in the present embodiment, the energy management server 2 switches the power management control from the edge control to the planning control when the target SOC (in the case described in FIG. 2, the target SOC=80%) at the scheduled departure time of electrified vehicle 12 is considered.

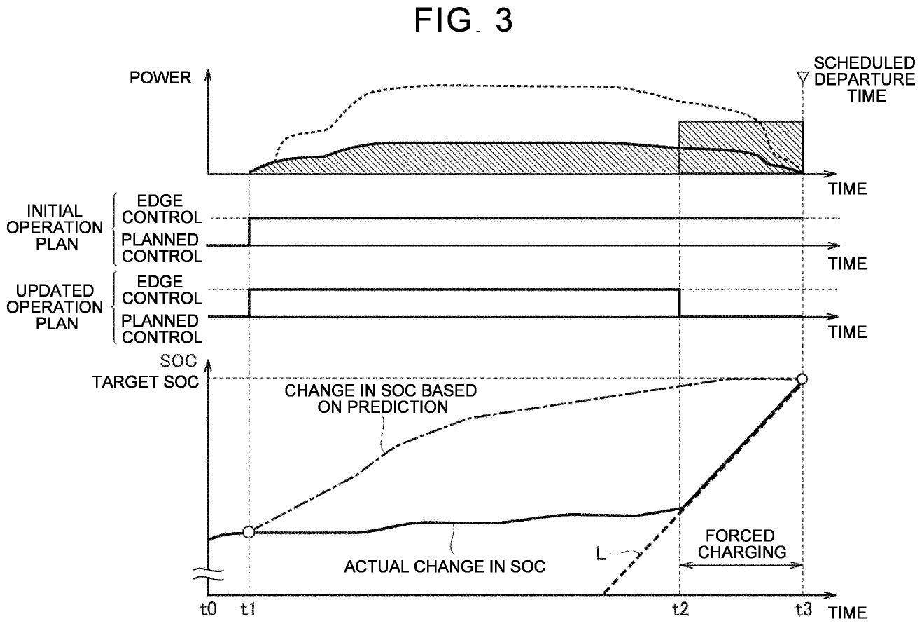

FIG. 3 is a diagram for explaining switching from edge-control to planning control. The horizontal axis represents elapsed time. The vertical axis represents, in order from the top, SOC of electric power, HEMS 10 operation planning (type of power management control), and electrified vehicle 12. As the operation plan, in addition to the operation plan at the start of the execution of the edge control, the operation plan after the update accompanying the above condition is satisfied is shown.

Planning control is executed in the initialization time t. In the time t1, switching from the planning control to the edge-control is performed. After the time t1, in the estimation, large surplus power is generated by PV power generation facility 14, and SOC of electrified vehicle 12 rapidly rises as indicated by a long dashed short dashed line. However, in practice, it is assumed that the surplus power generated by PV power generation facility 14 is not sufficiently generated, and SOC of electrified vehicle 12 increases only moderately, as indicated by a solid line.

In preparation for such a situation, the energy management server 2 sets the deadline L at, for example, the execution start time of the edge control. The deadline L is a line (in this case, a straight line) passing through the target SOC, and represents a virtual SOC transition when electrified vehicle 12 is forcibly charged by the electric power supplied from the charging equipment. The slope of the straight line is preferably determined based on the maximum power that can be supplied by the charging equipment and the maximum power that can be accepted by electrified vehicle 12 (the control upper limit Win for charging the storage battery). The larger the maximum power, the steeper the slope of the straight line.

When electrified vehicle 12 actual SOC crosses the deadline L, the energy management server 2 determines that the actual SOC cannot reach the target SOC at the scheduled departure time t3 of the electrified vehicle 12 when the edge-control is continued any longer. Therefore, at the time t2 when the actual SOC crosses the deadline L, the energy management server 2 switches the power management control from the edge-control to the planning control. Then, the energy management server 2 performs forced charging of the electrified vehicle 12 by recovering the control rights of (devices in the HEMS 10 including) the electrified vehicle 12 from HEMS controllers 15. This allows the actual SOC to reach the target SOC at the scheduled departure time t3.

In FIG. 3, the surplus electric power generated by PV power generation facility 14 falls below the predicted value. However, the surplus power generated by PV power generation facility 14 may be higher than the predicted amount. In such cases, it is desirable that the energy management server 2 suspends electrified vehicle 12's SOC when SOC of electrified vehicle 12 reaches the upper limit SOC. By setting the upper limit SOC to the target SOC (or close to the target SOC), the actual SOC at the scheduled departure time t3 can be more reliably brought closer to the target SOC.

In addition, when electrified vehicle 12 has an increased SOC and approaches the full charge SOC, it may be difficult to Demand Response (DR) using an electrified vehicle 12. Therefore, the energy management server 2 may set the upper limit SOC of the electrified vehicle 12 so that the electrified vehicle 12 still has DR power (which can be used for DR). The upper limit SOC is defined to have adequate margins for the full charge SOC.

### Process Flow

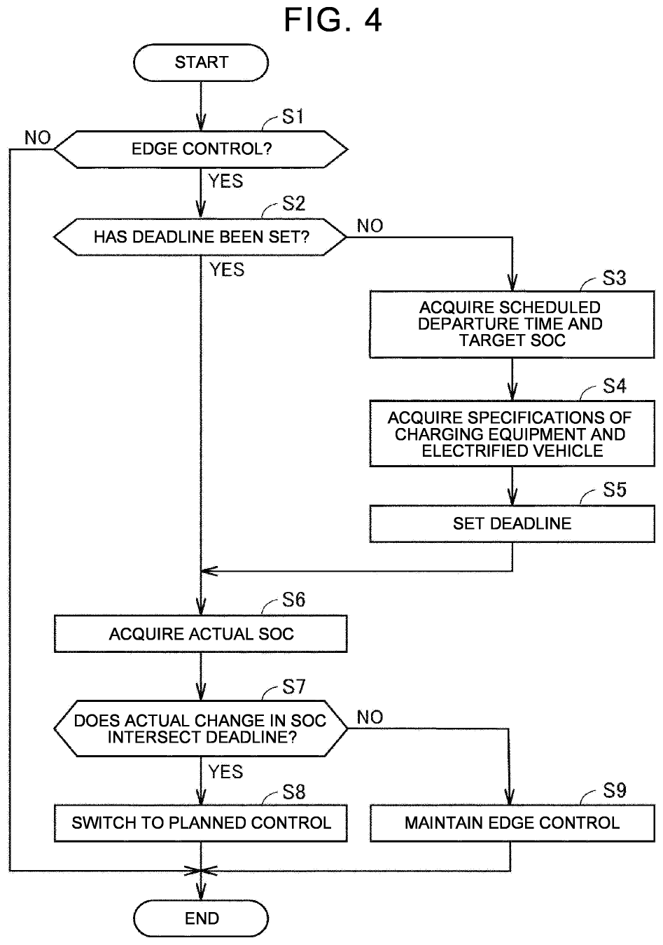

FIG. 4 is a diagram illustrating a procedure of power management control according to the present embodiment. The processing illustrated in this flowchart is executed when a predetermined condition is satisfied (for example, every predetermined cycle). Each step is realized by software processing by the energy management server 2, but may be realized by hardware (electric circuit) arranged in the energy management server 2. Hereinafter, the step is abbreviated as S.

In S1, the energy management server 2 determines whether or not edge-control is performed in the target HEMS 10. If no edge-control is performed (NO in S1), the energy management server 2 terminates the subsequent processes. When edge-control is performed (YES in S1), the energy management server 2 advances the process to S2.

In S2, the energy management server 2 determines whether the deadline L has been set. When the deadline L is not set (NO in S2), the energy management server 2 executes S5 process from S3 for setting the deadline L. When the deadline L is already set (YES in S2), the energy management server 2 skips S5 process from S3 and advances the process to S6.

In S3, the energy management server 2 acquires the scheduled departure time of electrified vehicle 12 and the target SOC of electrified vehicle 12. These values may be set by a user operation in advance, or may be estimated based on the driving history of the user. The energy management server 2 may directly acquire these values from electrified vehicle 12 through communication with electrified vehicle 12 or may acquire these values via HEMS controllers 15.

In S4, the energy management server 2 acquires specifications regarding the charging capacity of the charging equipment (typically, the maximum power that the charging equipment can supply) and specifications regarding the power reception capacity of electrified vehicle 12 (the control upper limit Win for charging the storage battery). These values may be collected in advance.

In S5, the energy management server 2 sets the deadline L based on the scheduled departure time of electrified vehicle 12 and the target SOC and the specifications of the charging equipment and electrified vehicle 12. Since this setting method is described above with reference to FIG. 3, the description thereof will not be repeated here.

When the deadline L is set (after YES or S5 process is executed in S2), the energy management server 2 acquires the actual SOC of electrified vehicle 12 through communication with electrified vehicle 12 or HEMS controller 15 (S6). Then, the energy management server 2 determines whether or not the actual SOC transition crosses the deadline L (whether or not the transition falls below the deadline L) (S7).

When the actual SOC transition does not intersect the deadline L (NO in S7), the energy management server 2 maintains the power management control of the target HEMS 10 in the edge-control (S9). On the other hand, when the actual SOC transition crosses the deadline L (YES in S7), the energy management server 2 switches the power management control of the target HEMS 10 from the edge-control to the planning control (S8). As a result, the series of processing ends.

As described above, in the present embodiment, the energy management server 2 sets the deadline L indicating the limit of whether or not the actual SOC can reach the target SOC at the scheduled departure time t3 of electrified vehicle 12, and determines whether or not the actual SOC transition crosses the deadline L. When the actual SOC transition crosses the deadline L, the energy management server 2 terminates the edge control, assuming that the continuation of the further edge control causes insufficient SOC for the target SOC, and executes the planning control instead. The energy management server 2 acquires the control right of electrified vehicle 12 and forcibly charges electrified vehicle 12. This allows the actual SOC of electrified vehicle 12 to reach the target SOC. Therefore, user convenience can be ensured.

It is to be understood that the embodiments disclosed herein are illustrative and non-restrictive in all respects. It is intended that the scope of the disclosure be defined by the appended claims rather than the description of the embodiments described above, and that all changes within the meaning and range of equivalency of the claims be embraced therein.

What is claimed is:

1. A power management system that manages power supply and demand in a power grid including a plurality of power balancing resources, the power management system comprising:
a controller configured to charge or discharge a corresponding resource that is a corresponding one of the power balancing resources; and
a server configured to set power management control to be performed on the corresponding resource by the controller, wherein
the power management control includes
first control in which the server has a control right of the corresponding resource and controls the corresponding resource based on a power supply and demand plan developed in advance, and
second control in which the controller has the control right and controls the corresponding resource based on an actual situation of surplus power and power demand of the corresponding resource,
the corresponding resource includes a storage battery that is chargeable with power supplied from external charging equipment, and
when a prediction is made during the second control that an actual state of charge of the storage battery is going to be lower than a target state of charge at a scheduled time to use the storage battery, the server switches the power management control from the second control to the first control.

2. The power management system according to claim 1, wherein when a prediction is made during the second control that the actual state of charge is going to be lower than the target state of charge, the server switches the power management control from the second control to the first control and performs forced charging of the storage battery with the charging equipment.

3. The power management system according to claim 2, wherein the server predicts, based on the target state of charge, a change in the state of charge of the storage battery that is reachable to the target state of charge when the forced charging is performed, and predicts that the actual state of charge is going to be lower than the target state of charge when the actual state of charge is not going to reach the target state of charge even when the forced charging is performed.

4. A power management method for managing power supply and demand in a power grid including a plurality of power balancing resources, the power management method comprising a setting step of setting, by a server, power management control to be performed on a corresponding resource by a controller, the corresponding resource being a corresponding one of the power balancing resources, wherein
the power management control includes
first control in which the server has a control right of the corresponding resource and controls the corresponding resource based on a power supply and demand plan developed in advance, and
second control in which the controller has the control right and controls the corresponding resource based on an actual situation of surplus power and power demand of the corresponding resource,
the corresponding resource includes a storage battery that is chargeable with power supplied from external charging equipment, and
the setting step includes a step of switching the power management control from the second control to the first control when a prediction is made during the second control that an actual state of charge of the storage battery is going to be lower than a target state of charge at a scheduled time to use the storage battery.
